(19) United States
(12) Patent Application Publication
(10) Pub. No.: US 2026/0123601 A1
(43) Pub. Date: May 7, 2026

(54) ANIMAL CONTAINMENT AND AUTOMATIC RELEASE ENCLOSURE

(71) Applicant: NM Ventures, LLC, Summerville, SC (US)

(72) Inventors: Neal Mallor, Ladson, SC (US); Matthew Gilmore, Scarsdale, NY (US); Lawrence Weckstein, Montvale, NJ (US); Mariusz Malkowski, Mendham, NJ (US); Edward Hart, Flanders, NJ (US)

(73) Assignee: NM Ventures, LLC, Summerville, SC (US)

(21) Appl. No.: 19/440,473

(22) Filed: Jan. 5, 2026

Related U.S. Application Data
(63) Continuation-in-part of application No. 18/986,430, filed on Dec. 18, 2024.
Application No. 18/986,430 is a continuation of application No. 18/232,957, filed on Aug. 11, 2023, now Pat. No. 12,207,622.

(51) Int. Cl. A01K 1/03; A01K 1/00; A01K 1/02; A01K 29/00

(52) U.S. Cl. CPC A01K 1/034; A01K 1/0064; A01K 1/0245; A01K 1/0272; A01K 29/005

(57) ABSTRACT

An animal containment and automatic release enclosure is disclosed featuring a unitary structure providing a secure interior space for animals. The enclosure incorporates ventilation apertures, enabling the animal to access fresh air for breathing and ventilation. Environmental sensors in wireless communication with a personal device continuously monitor the enclosure's conditions, ensuring the animal's well-being. Wirelessly controlled enclosure doors, operated by an electric enclosure door control device, provide convenient access to the enclosed animal. The system further integrates external sensors, such as a carbon monoxide sensor for monitoring external CO levels, a moisture detection pad sensor to identify liquid accidents, and a temperature sensor to regulate internal temperature. The enclosure is designed to cater to various environments, including those with potential carbon monoxide exposure, making it suitable for use in multiple settings. It can be employed by veterinarians, law enforcement personnel, military professionals, security experts, pet owners, and animals trained for specific tasks. Additionally, remote access is possible through a personal communication device.

### RELATED APPLICATIONS

The present application claims the benefit under 35 U.S.C. § 120 and is a continuation-in-part of U.S. patent application Ser. No. 18/986,430, filed on Dec. 18, 2024, which is in turn a continuation of U.S. patent application Ser. No. 18/232,957, filed on Aug. 11, 2023, now U.S. Pat. No. 12,207,622, each of which is herein incorporated by reference.

### FIELD OF THE DISCLOSURE

The present disclosure relates generally to an animal crate or carrier and more specifically to an animal containment and automatic release enclosure having enhanced features such as environmental sensors and remote operation.

### BACKGROUND OF THE DISCLOSURE

The inability to release a police dog from the back of a police vehicle, when necessary, presents significant difficulties and restrictions. Police canines are highly trained to assist officers in a variety of law enforcement situations, including the apprehension of suspects and the location of missing persons. However, if the dog is not promptly released, their efficacy is drastically diminished. The limited space of the police vehicle hinders the dog's mobility and ability to perform its duties effectively. In urgent situations where time is of the essence, delaying the dog's release may result in missed opportunities or the escalation of a potentially hazardous situation.

Moreover, the inability to deploy the police dog limits the officer's options and reduces their ability to effectively respond to dynamic and unpredictable situations. It is crucial for law enforcement agencies to ensure that the proper equipment and protocols are in place to allow for the prompt and secure release of police dogs when necessary, maximizing their role as indispensable assets in preserving public safety. Further, in situations that do not involve law enforcement, in the event of an emergency (such as a fire or carbon monoxide leak), conventional canine pets may be confined in their enclosures in the home. Consequently, there is a need for a device that can release service dogs and other pets remotely or autonomously from their enclosures during emergency situations. The development of an animal containment and automatic release enclosure satisfies this requirement.

### SUMMARY OF THE DISCLOSURE

The present application describes an innovative animal containment and automatic release enclosure with multiple features. The enclosure consists of four walls, a top, and a bottom, forming an interior space to accommodate an animal. It includes ventilation apertures in at least two walls, allowing the animal to access fresh air. The enclosure also incorporates environmental sensors in wireless communication with a personal device, such as a smartphone or tablet, to monitor conditions within and around the enclosure. The personal device can have an application thereon to monitor the condition of the enclosure and the outputs from the sensors.

Additionally, the enclosure is equipped with a gateway hub mounted externally, internally, or within walls of the enclosure. The gateway may also be removable from the enclosure entirely and can be taken by a user to a location that is remote from the enclosure, such as another room in a user's home or outside the home. The gateway communicates with all electronic devices associated with the enclosure. This gateway can use existing protocols like Z-wave, Zigbee, Wi-Fi, Bluetooth®, long-term evolution (LTE), Bluetooth® low energy (BLE), or other standard or proprietary protocols to facilitate communication. Moreover, the gateway hub contains a rechargeable battery and charging port, making the enclosure usable in various locations, even without AC power.

The enclosure features one or more doors that can be wirelessly controlled through electronic communication with the gateway hub. These doors can be unlocked, opened, closed, and locked using an electric enclosure door control device like a linear actuator or a servo drive.

One or more sensors are present in the enclosure to enhance safety and functionality. The sensors may be wired to a controller or may communicate with a controller wirelessly. These sensors include air quality sensors to measure levels of hazardous particulates, pollutants, or smoke (such as a PM 2.5 sensor), carbon monoxide sensors to monitor external CO levels, humidity sensors, a moisture detection pad sensor to detect liquid accidents, a light detection sensor, fire detectors, and a temperature sensor to track temperature levels around the enclosure. The sensors may also include those to detect unauthorized intrusion into the enclosure or escape of the animal. Such sensors could detect the door to the enclosure opening at an authorized time with vibration, accelerometer, or magnetic sensors. A main controller, along with a wireless transmitter, processes inputs from these sensors, enabling automatic actions based on the conditions. One of more of the sensors may be embedded in a sealed cavity in the roof of the enclosure or on one of the other walls, as discussed in greater detail below.

The enclosure is adaptable for various environments, including those with potential carbon monoxide exposure. The controls of the enclosure can remotely or automatically release enclosure doors in emergencies, allowing the contained animal to escape. Such emergencies include but are not limited to when any of the sensors of the preceding paragraph are triggered or reach threshold amounts, with a listening device that detects an external alarm, during a power failure or interruption, through the application discussed in greater below, or when the application otherwise determines that the pet within the enclosure is in distress. They can also contact emergency services such as fire or police when an adverse environmental condition is detected, security companies, the animal's veterinarian or pet care specialist, or other emergency contacts such as friends or family of the animal's owner. Such contacts could be granted audio and/or video access to the enclosure. The enclosure can be used by veterinarians, law enforcement personnel, military personnel, security professionals, pet owners, and dogs trained for various tasks. Additionally, the personal communication device controlling the enclosure may be a mobile phone adaptable to iOS, Android™, and other operating systems. Overall, the described enclosure offers advanced features for safe and efficient containment and release of animals.

In one embodiment, the present disclosure provides an animal containment and automatic release enclosure comprising: four enclosure walls; an enclosure top; an enclosure bottom, wherein the four enclosure walls, enclosure top, and enclosure bottom form an enclosure that defines an interior enclosure space; an enclosure door within one of the enclosure walls, wherein the enclosure door opens and closes to allow access to the interior enclosure space; a door control device attached to one of the four enclosure walls, enclosure top, and enclosure bottom; and a controller attached to one of the four enclosure walls, enclosure top, and enclosure bottom. The door control device is in communication with and controls the enclosure door to open and close. The controller is in communication with the door control device, and wherein the controller is configured to send a signal to the door control device to open or close the enclosure door.

In another embodiment, the present disclosure provides an animal containment and automatic release enclosure comprising: four enclosure walls; an enclosure top; an enclosure bottom, wherein the four enclosure walls, enclosure top, and enclosure bottom form an enclosure that defines an interior enclosure space; and an enclosure door within one of the enclosure walls, wherein the enclosure door opens and closes to allow access to the interior enclosure space. One of the four enclosure walls, the enclosure top, and the enclosure bottom is a hybrid wall made of a combination of metal and plastic.

In another embodiment, the present disclosure provides a method of transporting the animal containment and automatic release enclosure of either of the two preceding paragraphs, the method comprising the steps of: checking the enclosure with a transit carrier during a trip, wherein the enclosure will be in a secure location away from a user during the trip; and allowing the user to access the controller through a secure wireless portal.

### BRIEF DESCRIPTION OF THE DRAWINGS

The advantages and features of the present disclosure will become better understood with reference to the following more detailed description and claims taken in conjunction with the accompanying drawings, in which like elements are identified with like symbols, and in which:

FIG. 1 is a front perspective view of an enclosure according to one embodiment of the present disclosure.

FIG. 2 is a rear perspective view of the enclosure of FIG. 1.

FIG. 3 is a schematic drawing of the enclosure of FIG. 1 in a utilized state.

FIG. 4 is a cross-sectional view of enclosure of FIG. 1, as seen along line I-I of FIG. 1.

FIG. 5 is an electrical block diagram of the enclosure of FIG. 1.

FIG. 6 is a top view of an enclosure according to a second embodiment of the present disclosure.

FIG. 7 is a perspective view of the enclosure according to FIG. 6.

FIG. 8 is a first side view of the enclosure according to FIG. 6.

FIG. 9 is a second side view of the enclosure according to FIG. 6.

FIG. 10 is a second perspective view of the enclosure according to FIG. 6.

FIG. 11 is a third perspective view of the enclosure according to FIG. 6.

FIG. 12 is an exploded view of the enclosure according to FIG. 6.

FIG. 13 is an enlarged view of a portion of the enclosure according to FIG. 6.

FIG. 14 is a perspective view of a third embodiment of an enclosure according to the present disclosure.

FIG. 15 is a perspective view of a fourth embodiment of an enclosure according to the present disclosure.

FIG. 16 is a second perspective view of the enclosure according to FIG. 15.

FIG. 17 is a perspective view of a fifth embodiment of an enclosure of the present disclosure.

### DESCRIPTIVE KEY

10 animal containment and automatic release enclosure
15 wall
20 floor
25 top
30 door
35 foot
40 ventilation opening
45 door control device
50 gateway hub enclosure
55 charging port
60 rechargeable battery
65 carbon monoxide (CO) sensor
70 corner reinforcement
75 internet
80 first radio frequency (RF) wave
85 mobile telephone network
90 second radio frequency (RF) wave
95 personal communication device
97 application
98 program
99 camera
100 user
105 animal
110 moisture detection pad sensor
115 temperature sensor
117 humidity sensor
120 charge controller
125 main controller
130 wireless transmitter
135 interconnection wiring
210 enclosure
215 walls
216 feed chute
217 wall border portion
217a air gap
218 component enclosure
219 wall center portion
220 floor
222 floor border portion
224 floor center portion
225 top
227 top border portion
229 top center portion
230 door
232 door border portion
234 door center portion
240 cam lock
242 wall edges
244 wall grooves or channels
310 enclosure
315 side wall
319 inner portion
325 top
410 enclosure
415 wall
419 wall center portion
425 top
429 top center portion
430 door
434 door center portion
510 enclosure
515 door
519 door center portion
525 top
529 top center portion
530 door
534 door center portion

### DETAILED DESCRIPTION OF THE DISCLOSURE

### 1. Detailed Description of the Figures

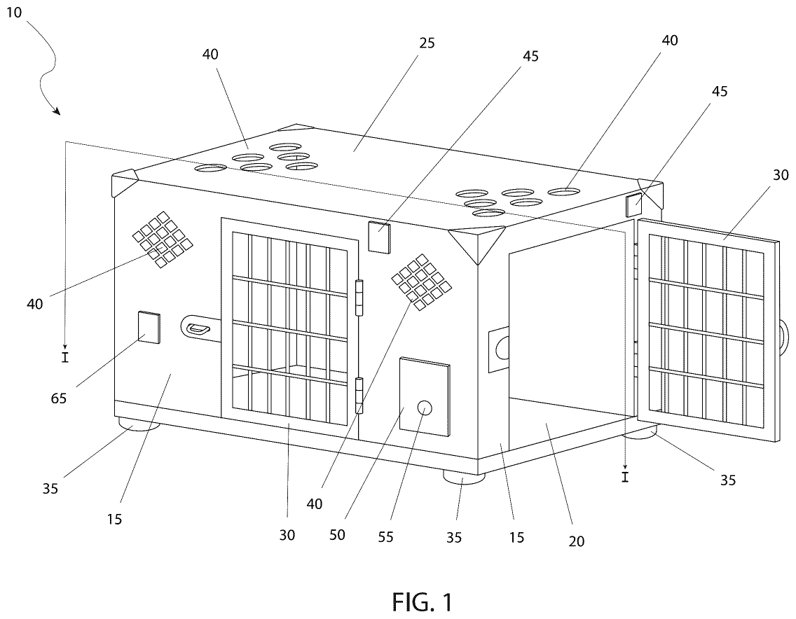

Referring now to the FIGURES, and in particular FIG. 1, a front perspective view of the animal containment and automatic release enclosure 10, according to one embodiment of the present disclosure is disclosed. The animal containment and automatic release enclosure (herein also described as the “enclosure”) 10, provides for remote or automatic release of at least one (1) door 30 of the enclosure 10 depending on certain external conditions. It is intended for use by law enforcement animals 105 and/or domestic pets (such as dogs, cats, rabbits, or other household pets). The enclosure 10 is a six-sided structure comprising four (4) walls 15, a floor 20, a top 25, and at least one (1) door 30. The enclosure 10 is supported by four (4) feet 35 (of which only three (3) are shown due to illustrative limitations) and is equipped with multiple ventilation openings 40 to allow for breathing and ventilation of the contained animal 105. The present disclosure contemplates that enclosure 10 may not have any feet 35. Each door 30 is equipped with a door control device 45 to allow for both opening and closing of thereof. The door control device 45 is of an electric or electro-mechanical nature and may be a linear actuator, a servo drive, a dual solenoid/spring device, or the like. Door control device 45 may also be a non-contact electronic or electric mechanism, such as an electrically controlled magnet. As such, the use of any specific device serving the function of the door control device 45 is not intended to be a limiting factor of the present disclosure. Further, in the shown embodiments door 30 is a hinged door that pivots on hinges or an axis to one side of the door, but the present disclosure contemplates other kinds of doors, such as sliding doors that run in a track. The type of animal 105 suitable for use with enclosure 10 is not particularly limited, and can be for example a dog, cat, or other domesticated animals.

In the shown embodiment, the exterior of the enclosure 10 is provided with a gateway hub enclosure 50 that communicates with other electronic devices as will be shown below. As noted above, the gateway hub enclosure 50 may be in an interior of enclosure 10, or embedded within one of the walls of enclosure 10, as in the embodiments described below. It can also be removably connected to enclosure 10 so that a user can take it into another room or outside the home. Typically, the gateway hub enclosure 50 would be mounted to an exterior surface of a wall 15. The gateway hub enclosure 50 is equipped with a charging port 55 for charging a rechargeable battery 60 (not shown due to illustrative limitations). Operation of the enclosure 10 with battery 60 allows use of the enclosure 10 in all locations, including mobile use, whether or not alternating current (AC) power is available. The gateway hub enclosure 50 also allows for communication with a personal communication device 95 such as mobile telephones, tablet computers, notebook computers, desktop computers, home automation panels, proprietary platforms or the like. The gateway hub enclosure 50 may use existing protocols such as Z-wave, Zigbee, Wi-Fi, Bluetooth®, LTE, BLE, or other standard or proprietary protocols. The external communication protocols used by the enclosure 10 are not intended to be a limiting factor of the present disclosure. The enclosure 10 also contains a carbon monoxide sensor 65 on its external surface for monitoring of carbon monoxide (CO) levels external to the enclosure 10. As previously described, sensor 65 can be a more general air quality sensor that measures the air quality in terms of particulate concentration, in conjunction with or instead of carbon monoxide levels. Such monitoring ability is viewed as being valuable should the enclosure 10 be used in a motor vehicle (such as with the case of animals 105 such as dogs used in law enforcement, drug detection, bomb detection, life-saving, or the like), in a garage, basement, or other location where carbon monoxide (CO) may be present.

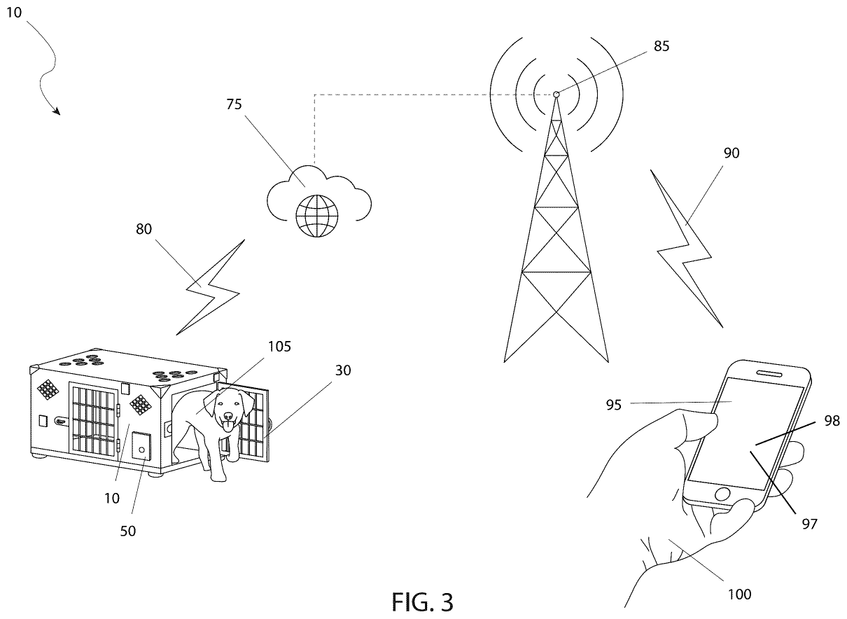

In one embodiment (FIG. 3), an application 97 resides on device 95 so that a user 100 may monitor the status of enclosure 10 and the sensors described in greater detail below. Application 97 can have a program 98 thereon, where program 98 is configured to allow user 100 to set up a personal account, link device 95 to enclosure 10, control the release of door 30, facilitate audio and visual communication with animal 105 while animal 105 is in enclosure 10 in the manner described below, and provide an interface for user 100. Thus, all of the features described herein (e.g., live video and audio access, and two-way video and audio) can be seamlessly integrated for user 100 to operate on a mobile phone, or a portable tablet, such as a 5-inch to 14-inch tablet. Application 97 can also reside on a stationary computing device such as a personal computer. There may also be a user interface (not shown) on enclosure 10, to allow for the user functions described in this paragraph, such as control of door 30 or initiating audio or visual communication.

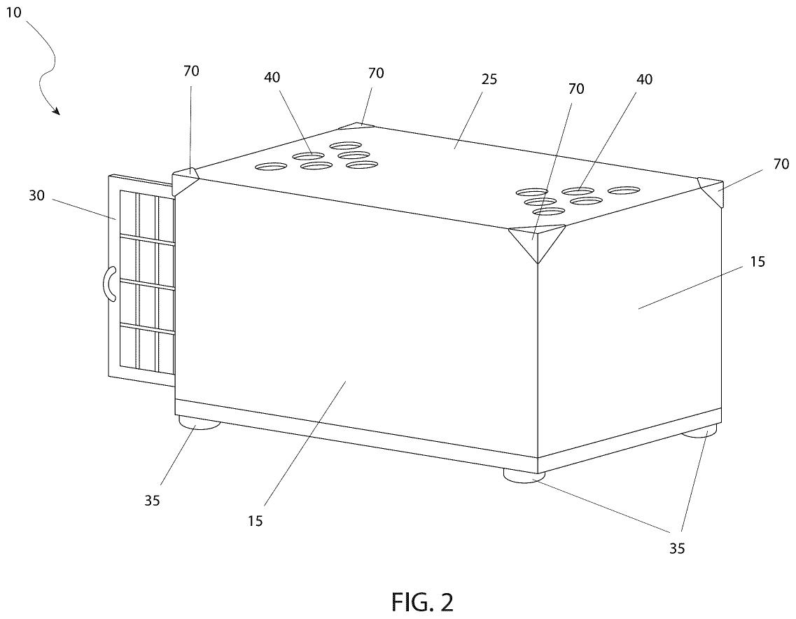

Referring next to FIG. 2, a rear perspective view of the enclosure 10 according to the preferred embodiment of the present disclosure is depicted. As previously disclosed, the enclosure 10 provides for four (4) sections of walls 15 with a top 25 piece. The top 25 is provided with ventilation openings 40. Corner reinforcements 70 may be utilized if needed depending on physical usage conditions. Three (3) of the four (4) feet 35 are visible. Finally, the door 30 remains visible in its open position on the far wall 15.

Referring now again to FIG. 3, a pictorial view of the enclosure 10, shown in a utilized state, according to the preferred embodiment of the present disclosure is shown. The gateway hub enclosure 50 is in communication with the internet 75 using a first radio frequency (RF) wave 80 as previously described. Using conventional pathways, the internet 75 is connected to a mobile telephone network 85. A second radio frequency (RF) wave 90 is communication with the personal communication device 95 held by the user 100. The personal communication device 95 may be a mobile telephone as shown, or virtually any type of communication device that can be connected to the internet 75. In the instance of a mobile telephone, the personal communication device 95 and application 97 would be adaptable to both the iOS or Android™ operating system. The user 100 is envisioned to be a handler of animals 105 in practice, such as that would be expected by veterinarians, law enforcement personnel, military personal, security professionals, pet owners, drug dogs, explosive and contraband detection dogs, and the like. In the event of an emergency, as determined by the associated electronics of the enclosure 10, such as the carbon monoxide (CO) sensor 65 (as shown in FIG. 1), or others to be described herein below, or by the user 100, commands may be issued by the personal communication device 95 (in one embodiment through application 97) to open all doors 30 (as shown in FIG. 1) to allow the contained animal 105 to exit. As the user 100 may be anywhere in the world, access may be granted by the user 100. Such remote access is also envisioned as valuable should the user 100 be on a different floor of a residence from the enclosure 10, or away from a vehicle containing the enclosure 10. It may also be used during training of the animal 105 for food aggression dogs, personal security guard dogs, and those who crate their animal 105 and need instant access to remotely open and close the enclosure 10. They can also contact emergency services such as fire or police when an adverse environmental condition is detected, security companies, the animal's veterinarian or pet care specialist, or other emergency contacts such as friends or family of the animal's owner. Such contacts could be granted audio and/or video access to the enclosure.

There may also be an emergency call button on application 97 and/or enclosure 10 that can automatically call 911 (fire or police), security companies, the animal's veterinarian or pet care specialist, or other emergency contacts such as friends or family of the animal's owner when one or more of the sensors described herein detects that the parameters they are measuring are outside of desired values. In the event of a pet health emergency, application 97 may automatically start audio and/or visual communication between any of these emergency services or contacts and enclosure 10, or between each other (e.g. the veterinarian for animal 105 and the pet's owner, to determine and advise what the pet owner should do). Application 97 may also play calming music and display soothing lights with the intent of this having a calming effect on the pet. Application 97 may also play video and audio content for the animal 105 and/or the pet's owner, which can be played on device 95 or a user interface within enclosure 10. Application 97 may link with the streaming service accounts of the user or owner of animal 105.

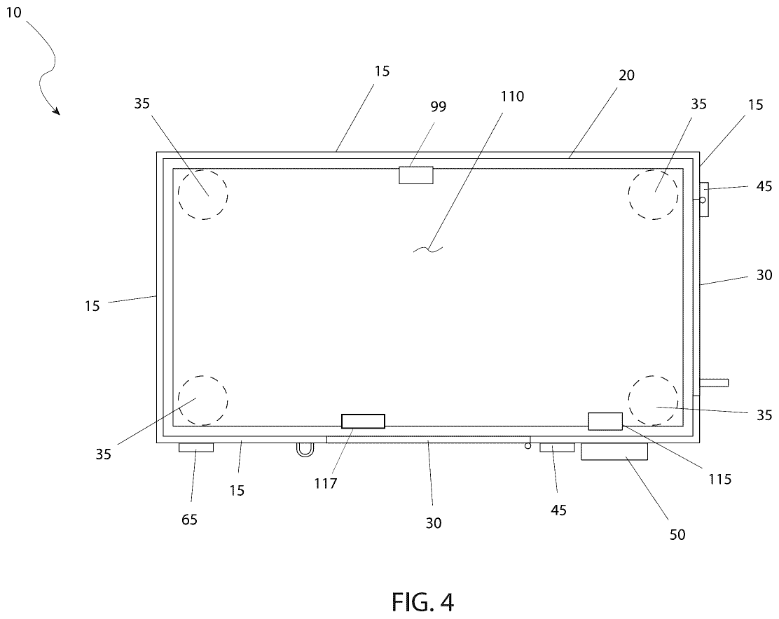

Referring next to FIG. 4, a sectional view of the enclosure 10, as seen along line I-I of FIG. 1 is shown. The four (4) feet 35 are shown via dashed lines, due to their hidden nature. A moisture detection pad sensor 110 is provided on the entire surface of the floor 20, up to the confines of the walls 15. The moisture detection pad sensor 110 detects if the animal 105 (as shown in FIG. 3) has urinated, spilt water, or had another type of accident involving a liquid in the enclosure 10. Such an event would produce a notification on the personal communication device 95 (as shown in FIG. 3) and indicate the animal 105 had an accident in their enclosure 10 as sensed from the moisture detection pad sensor 110, thus alerting the user 100 (as shown in FIG. 3) to take corrective action. A temperature sensor 115 detects excess hot or cold temperature levels. The gateway hub enclosure 50 (as shown in FIG. 1), provides notification of temperature to the personal communication device 95, and automatically opens any door 30, via the door control device 45, in the instance of extreme and dangerous temperatures. The carbon monoxide (CO) sensor 65 operates in a similar manner to the temperature sensor 115 with regards to remote operation and automatic opening of the doors 30 in an emergency situation. As previously discussed, a humidity sensor 117 can be within the enclosure, report the humidity level in the area around and within enclosure 10, and communicate with gateway hub enclosure 50 and/or personal device to alert of an unsafe humidity condition. As previously discussed, instead of or in conjunction with sensors 65, 115, and 117, other sensors can be used in enclosure 10, such as air quality sensors to measure levels of hazardous particulates, pollutants, or smoke (such as a PM 2.5 sensor), a moisture detection pad sensor to detect liquid accidents, a light detection sensor, fire detectors, and those to detect unauthorized intrusion into the enclosure or escape of the animal (e.g. vibration, accelerometer, or magnetic sensors). Door 30 can also be opened manually in the event of failure of any of the electrical or electronic components described herein.

Enclosure 10 may also have a camera 99 therein. Camera 99 may communicate with gateway hub enclosure 50 in the manner described in greater detail below. Camera 99 can be a two-way camera and have a speaker, so that user 100 may obtain visual and audio of the interior or exterior environment of enclosure 10, as well as provide animal 105 with audio or visual communication or content. Camera 99 will communicate with the personal device 95, for example through application 97. In one example, user 100 may use application 97 to enable camera 99 to show animal 105 the face of user 100 and let animal 105 hear the voice of user 100, which may help to soothe animal 105 if they are agitated or stressed.

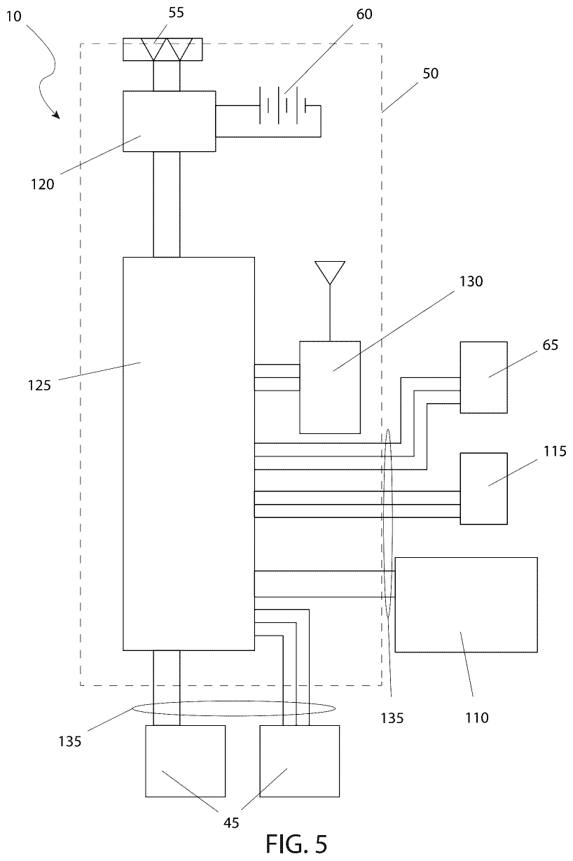

Referring to FIG. 5, an electrical block diagram of the enclosure 10, according to an embodiment of the present disclosure is depicted. External electrical power is introduced to the enclosure 10 via the charging port 55 and is directed to a charge controller 120. In turn, the charge controller 120 maintains an electrical charge upon the rechargeable battery 60 and provides uninterrupted power to a main controller 125. Should electrical power be removed from the charging port 55, the rechargeable battery 60 provides adequate capacity to maintain operation of the enclosure 10 for an extended period of time. The main controller 125 is provided with input signals from the carbon monoxide (CO) sensor 65, the temperature sensor 115 and the moisture detection pad sensor 110, and will make automatic, parameter-based actions depending on the values received. Although not explicitly shown in FIG. 5, humidity sensor 117 and camera 99 can connect to main controller 125 in the same way. Additionally, the wireless transmitter 130 provides both input and output functionality to the main controller 125 and allows for sending of notifications and receiving commands from the wireless transmitter 130. The main controller 125, envisioned to be a single board computer (SBC) such as a RaspberryPi®, Arduino®, or the like, provides notification if any door 30 (as shown in FIG. 1) were manually opened as well as a log of all operations, including sensor values from the carbon monoxide (CO) sensor 65, the temperature sensor 115, the moisture detection pad sensor 110, the humidity sensor 117, and camera 99. The main controller 125 provides output signals to any door control devices 45 to unlock, open, close, and lock the respective door 30. It is noted that the charging port 55, the rechargeable battery 60, the charge controller 120, the main controller 125, and the wireless transmitter 130 are all contained within the gateway hub enclosure 50. Remote items to the gateway hub enclosure 50, such as the carbon monoxide (CO) sensor 65, the temperature sensor 115, the moisture detection pad sensor 110, the door control device 45, humidity sensor 117, and camera 99 are provided with interconnection wiring 135.

Main controller 125 may also have an artificial intelligence (AI) module or program associated therewith that can be used to speed up and enhance the detection and treatment of the animal 105 by controller 125, owners, and/or by pet professionals. AI may be able to learn certain conditions that typically trigger a release, such as a rise in humidity or temperature, may be able to predict when a trigger event requiring the opening of door 30 is about to happen, and can send a notification in advance of that event. The AI module can use the input from the sensors (65, 115, 117) or other data input methods described above to learn pet behavior over time. The AI module may also offer diagnosis of health related issues as well as potentially trigger the automatic dispensation of anxiety reducing and comforting/calming therapeutics such as dispensing comforting lighting, video, music, aromatherapy, a 2-way call, food, or other remedies.

The materials used for enclosure 10, in particular for walls 15, floor 20, top 25, and door 30, can vary depending on the demands that are placed on enclosure 10 by the environment in which it is used or by animal 105. For example, if animal 105 is a large, aggressive dog with aggressive chewing habits, metal would be a suitable material to use. With smaller dogs or more docile pets such as cats, an enclosure including both metal and plastic could be used, or an enclosure entirely made of plastic. Metal provides sturdiness and durability, where plastic reduces weight, allows for flexibility of locating components (as discussed in greater detail below), and provides more ability than metal to customize the appearance of the enclosure with different color schemes. The needs of a particular application will dictate which of these concerns may be more important. The enclosures of the present disclosure can use a mix of materials for construction, for example walls that are made of metal and plastic that can be co-formed or co-molded. The materials used for the enclosures described herein can also be glass, tempered glass, privacy tempered glass (i.e. glass that is at least partially tinted), standard privacy glass, plexiglass, or privacy plexiglass.

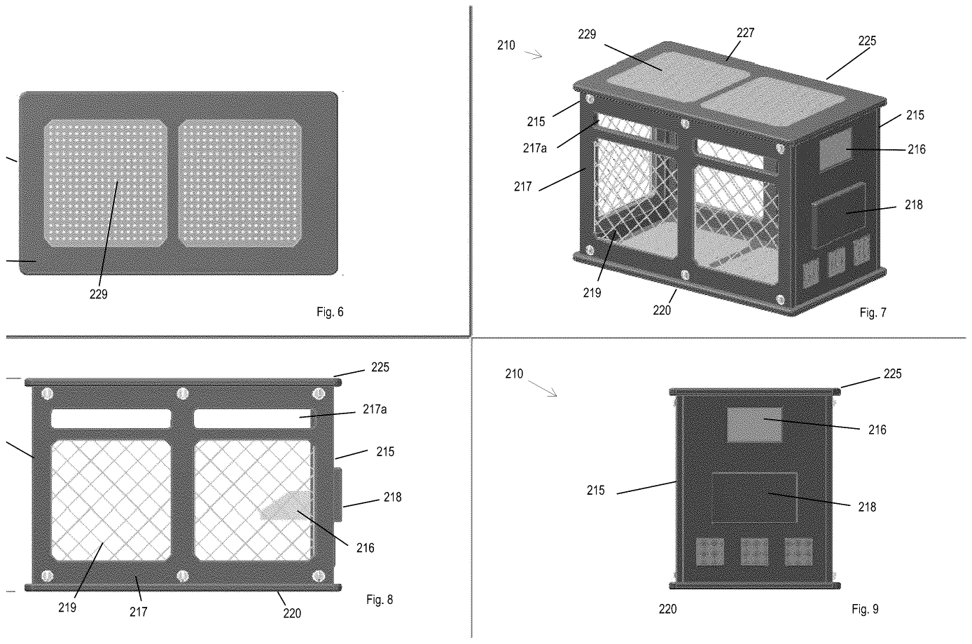

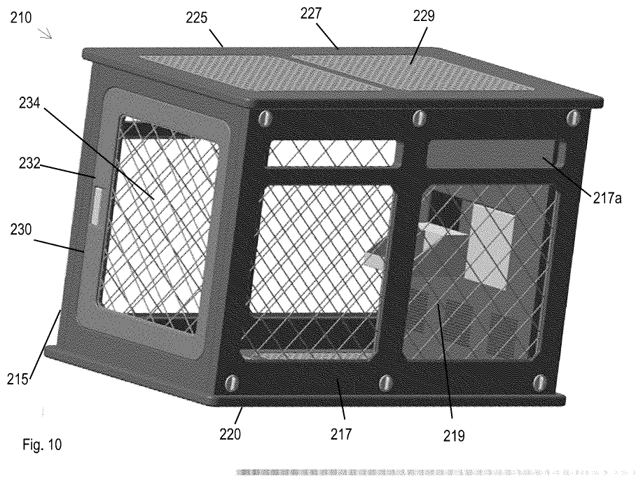

Referring to FIGS. 6-13, a second embodiment of the enclosure of the present disclosure is shown and referred to with numeral 210. Similarly to enclosure 10, enclosure 210 has four walls 215, floor 220, top 225, and door 230. Although not shown for the sake of simplicity, enclosure 110 can have any or all of the same features described above with respect to enclosure 10, such as but not limited to a door control device to open door 230, one or more sensors that can monitor conditions within enclosure 210, and a personal communication device that can communicate with the sensors.

Enclosure 210 includes both plastic and metal components. In the shown embodiment, top 225 has a border portion 227 that surrounds and holds one or more center portions 229 in place. Border portion 227 can be made of a plastic, and center portion(s) 229 can be made of a metal, which can be perforated to provide airflow. At least one of walls 215 has a border portion 217 that holds one or more center portions 219 in place. One of walls 215 can be mostly solid, and have a component enclosure 218 for storing components therein, as discussed in greater detail below. One of walls 215 can also have a feed chute or tray 216 that is connected thereto and projects into the interior of enclosure 210. Feed chute can have an opening on the opposite side of wall 215 from the interior of enclosure 210, so that a user can place food in the chute for the animal to consume without the user needing to open enclosure 210. Floor 220 can have a border portion 222 that surrounds one or more center portions 224. Door 230 can have a border portion 232 that surrounds one or more center portions 235.

In the shown embodiment, border portions 217, 222, 227, and the majority portion of wall 215 with housing 218 are made of plastic. Center portions 219, 224, and 229 are made of metal, and can either have small perforations (as in center portions 224 and 229) or be more like a chain-link or grill pattern with mostly open space (as in center portion 219). Thus, enclosure 210 provides the benefits of both metal and plastic construction. The plastics in enclosure 210 provide rigidity, durability, light weight, and the ability to customize colors or emboss logos or other text. Plastics can also be molded or formed so as not to provide edges for an animal to chew on. Further, plastics may give a more pleasant or welcoming appearance to the enclosure than one made entirely of metal. The metal portions of the enclosure provide additional or enhanced strength and durability.

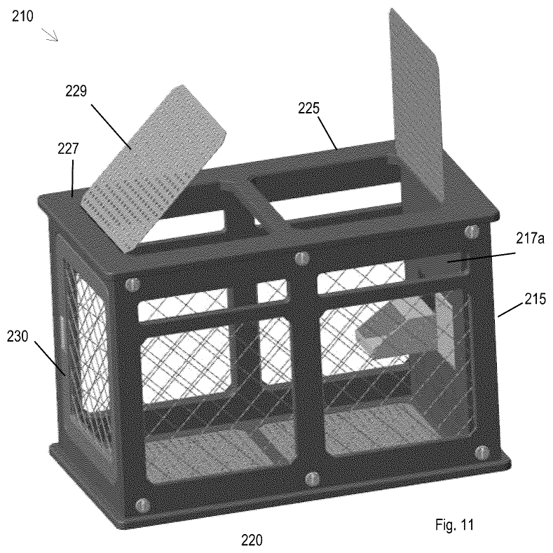

FIG. 11 shows that center portion 229 of top 225 can swing outwards, to that the inside of enclosure 210 can be accessed. Any of center portions 219, 224, and 229 can have this functionality. They can also be slidable on tracks or grooves in wall 215.

The plastic materials included in enclosure 210 or any of the other enclosures described herein can be produced by blow-molding or blow-molding with double wall construction, meaning that the resulting plastics are at least partially hollow. This keeps the weight of the materials relatively low, and allows for components to be stored therein, as discussed in greater detail below. Blow molding also allows for the inclusion of features such as channels, male/female matching details, snap-ins, hinges and receptacles. The plastics can also be made via injection molding, roto molding, thermoforming, or fabrication. Any of these methods can allow the manufacturer to make the walls as thin or as thick depending on the needs of the particular enclosure design.

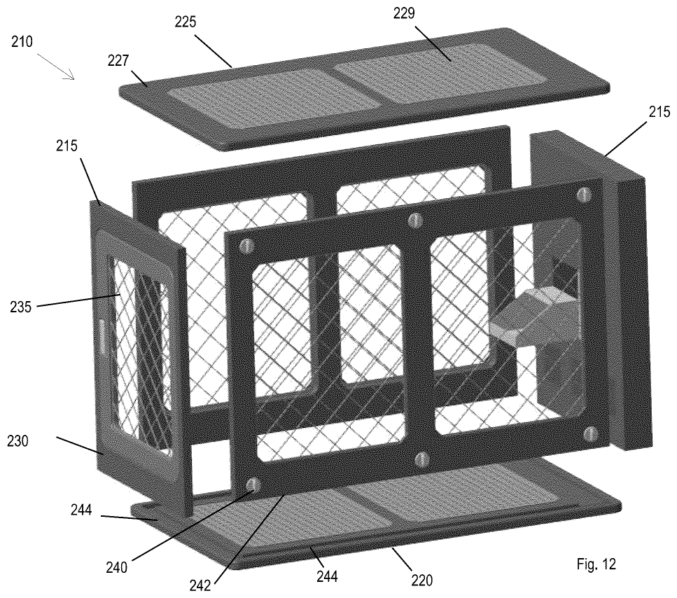

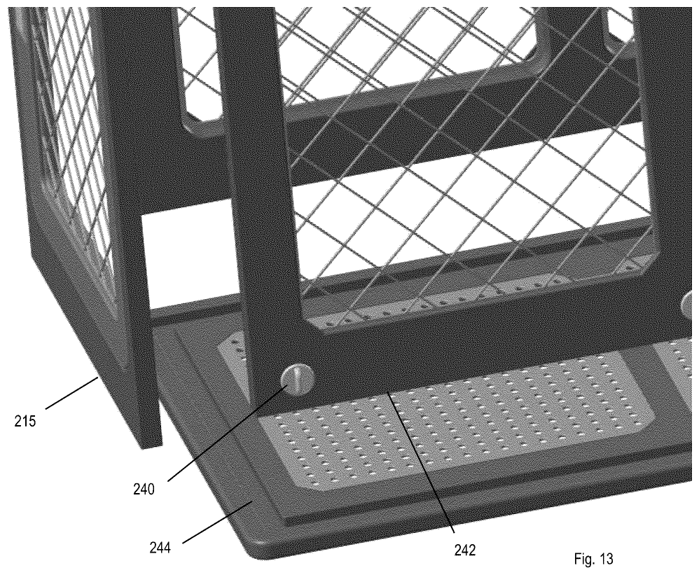

For example, border portions 217, 222, and 227 can be molded so that metal center portions 219, 224, and 229, respectively, can snap-fit to one another. In addition, referring to FIGS. 12 and 13 specifically, one or more of walls 215, floor 220, and top 225 can have grooves or channels 244 molded therein that can mate with edges 242 of adjoining walls 215, floor 220, and/or top 225. A plurality of cam locks 240 can be located on one or more of walls 215, floor 220, and top 225, to lock adjoining surfaces together via channels 244. Cam locks 240 can be separately molded and pressed into pockets in walls 215, floor 220, and top 225. This also provides a modular and interchangeable capability, where walls 215, floor 220, and top 225 can be disassembled and reassembled very easily for transport or otherwise, or different components can be swapped out. The modularity also allows for enclosure 210 to grow as animal 105 grows.

One of the sides of enclosure 210, for example one of walls 215, can serve as a smart wall panel, in that it can contain the components that enable the monitoring and reporting functions of the enclosure. For example, a gateway hub enclosure, a controller, and/or one or more of the sensors described above with respect to enclosure 10 can be within housing 218. In this embodiment, wall 215 having housing 218 would be thicker than other walls 215. Circuitry could be within the other walls 215, so that when they are all assembled, a circuit with any components within housing 218 can be completed. It may also be that some components such as sensors can be within or connected to walls 215, and bulkier or more delicate components such as a processor and controller can be within housing 218.

Suitable plastics for use in the enclosures of the present disclosure include high-density polyethylene (HDPE), low-density polyethylene (LDPE), polypropylene (PP), polyvinyl chloride (PVC), polyethylene terephthalate (PET), thermoplastic elastomers (TPE), acrylonitrile butadiene styrene (ABS), polyphenylene oxide (PO), nylon, polyamides (PA), polycarbonate (PC), polyester, co-polyester, urethane, polyurethane, acrylic, polystyrene, and any combinations or mixtures thereof. Suitable metals include steel, aluminum, brass, and others, or any combinations thereof. As previously discussed, the walls or center portions of any of the enclosures described herein can be made of glass, tempered glass, privacy tempered glass (i.e. glass that is at least partially tinted), standard privacy glass, plexiglass, or privacy plexiglass.

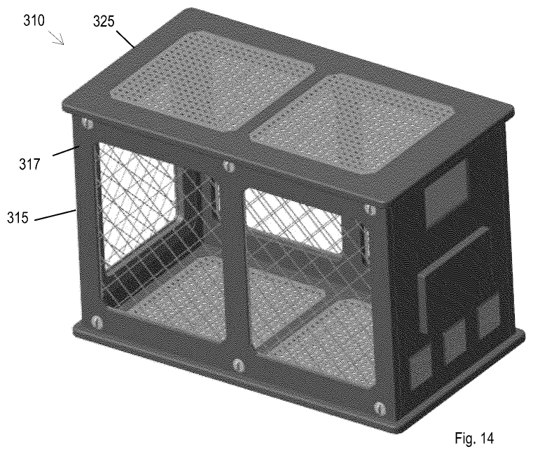

Referring to FIG. 14, a third embodiment of the enclosure of the present disclosure is shown with reference numeral 310. Enclosure 310 is identical to enclosure 210 with one exception. Border portion 317 of side wall 315 of enclosure 310 extends all the way to top 325. This is in contrast to inner portion 217, which has an air gap 217a at its top. Including an air gap may allow for greater air circulation and reduce the weight of the enclosure. In some cases, it may be beneficial to have center portion 319, to provide a full enclosure for the animal and to add strength.

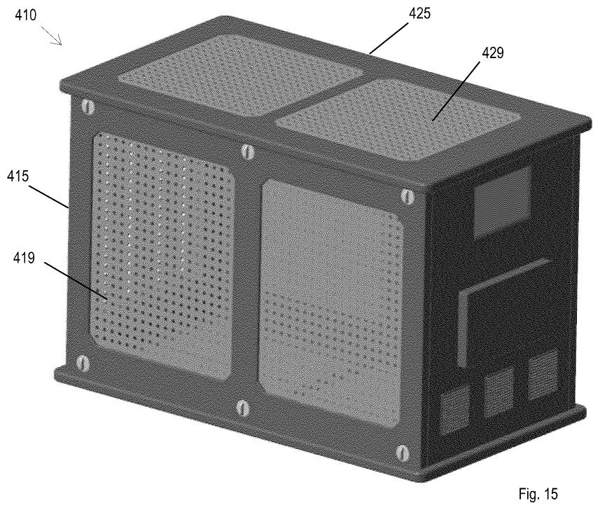

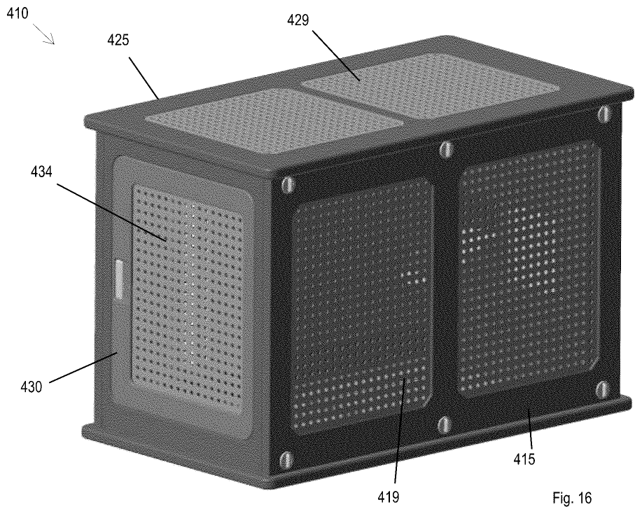

Referring to FIGS. 15-16, a fourth embodiment of the enclosure of the present disclosure is shown with reference numeral 410. Enclosure 410 is identical to enclosures 210 and 310 with the following exception. In enclosure 410, inner portions 419 of side walls 415, as inner portions 429 of top 425, and inner portion 434 of door 430 are each made from a perforated metal or plastic material, as opposed to the chain-link type inner portions of prior embodiments.

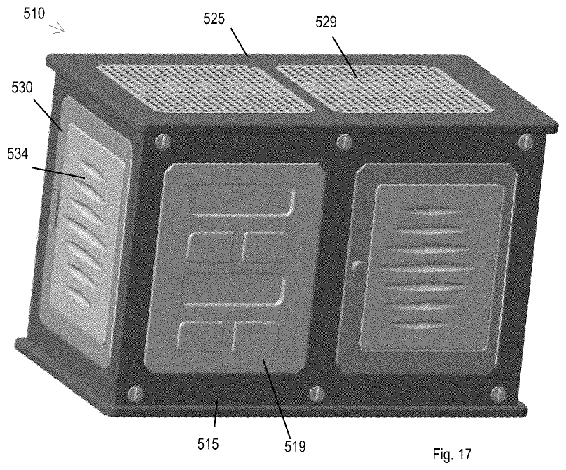

Referring to FIG. 17, a fifth embodiment of the enclosure of the present disclosure is shown with reference numeral 510. Enclosure 510 is identical to enclosures 210, 310, and 410 with the following exception. In enclosure 510, inner portions 519 of side walls 515 and inner portion 534 of door 530 are made from a solid metal or plastic material without any openings or perforations, as opposed to the chain-link type inner portions of prior embodiments. One of inner portions can have a knob 519a thereon, so that a user can open inner portion 519 to access the interior of enclosure 510. Inner portions 529 of top 525 may also be made of solid material without any openings or perforations.

In any of the embodiments disclosed herein, the controllers of the enclosures may have a feature whereby they can record and store the voice of the owner, caretaker, or veterinarian of animal 105, or the voice of animal 105. The controllers can then listen for those voices, and upon recognition, can release door 30. For example, if the owner of animal 105 is near the enclosure, the controller can be configured to allow the owner to release door 30 by speaking.

In any of the embodiments disclosed herein, the controllers of the enclosures may have a feature whereby the position of the owner of animal 105 (via device 95) can be detected. This can be done with geolocating technology such as global positioning satellites, Wi-Fi network positioning, cell tower triangulation, or the like. The controller can be configured to release door 30 when the owner is within a certain distance of the enclosure.

### 2. Operation of an Embodiment

One embodiment of the present disclosure can be utilized by the common user in a simple and effortless manner with little or no training. It is envisioned that the enclosure 10 would be constructed in general accordance with FIG. 1 through FIG. 5. The user 100 would procure the enclosure 10 from conventional procurement channels such as pet stores, veterinarian supply houses, law enforcement supply houses, military suppliers, and the like. Special attention would be paid to the overall size of the enclosure 10, such that it would fit in the desired location as well as being appropriate for the size of the animal 105.

After procurement and prior to utilization, the rechargeable battery 60 would be charged by connecting an external power source to the charging port 55 for an appropriate period of time. The wireless transmitter 130 included in the gateway hub enclosure 50, would be paired and active with the appropriate monitoring system (Z-wave, Zigbee, Wi-Fi, or the like). The personal communication device 95 would be interconnected with the appropriate monitoring system if not already done so. The enclosure 10 would be placed in the area of intended use. At this point in time, the enclosure 10 is ready for utilization.

During utilization of the enclosure 10 in an automatic manner, the animal 105 would be placed in the enclosure 10 and all doors 30 secured in a conventional manner. Should excessive high or low temperatures, a rapid and significant change in temperature, smoke, or excessive carbon monoxide (CO) levels be detected by any sensors (such as the temperature sensor 115 and the carbon monoxide (CO) sensor 65), the main controller 125 will automatically open all doors 30 and provide notification to the personal communication device 95. Controller 125 can also be configured to open doors 30 in the event of a loss of power.

During utilization of the enclosure 10 in a manual/remote manner, all levels from the carbon monoxide (CO) sensor 65, the temperature sensor 115 and the temperature sensor 115 will be provided to the personal communication device 95 on a continuous basis, along with the open/close status of any doors 30 as controlled by the door control device 45. Should the user 100 wish to open or close any doors 30, the user 100 may issue a command to do so. Such actions are viewed as advantageous to law enforcement officers, military personnel, emergency personnel, or anyone who enlists the services of a trained animal 105. Such services are also beneficial to users 100 who are veterinarians, trainers, and pet owners who wish to control access to and from the enclosure 10 from a remote location.

In another embodiment, any of the enclosures described herein can be used to allow the owner or operator of animal 105 to remotely view, communicate with, and monitor animal 105 when animal 105 and the enclosure are being transported for airline or other secure travel. This allows the owner and operator to have visibility into the enclosure's key safety, wellness, and environmental control features while in transit. In this embodiment, gateway hub 50 and the other controllers of the enclosure provide live video and audio feed from within the enclosure (for example to device 95), allowing the owner to visually check on animal 105. This feed can optionally be two-way audio and/or video communication, so the owner can speak to animal 105 for reassurance. The access to the enclosure in this way would be secure and limited to the owner or other authorized parties during transport.

As previously discussed, one or more sensors (e.g., carbon monoxide sensor 65) can be in communication with gateway hub 50 and controller 125 while the enclosure is in transit. Gateway hub 50 and controller 125 will provide a dashboard to the owner on device 95, which can display sensor data relating to one or more of the following: the internal temperature of the enclosure; the humidity in the enclosure; the air quality and ventilation status in the enclosure; the power and battery status of the enclosure; the state of door 30 and lock 45; any alarm, fault, or alert conditions; and indicators relating to motion or activity of animal 105. This allows the owner to confirm that animal 105 and that environmental conditions remain within acceptable ranges throughout transport.

Because aircraft cargo and luggage compartments can experience significant temperature variation, including cold conditions at cruising altitude and heat exposure during ground handling, the enclosures of the present disclosure support active and/or adaptive environmental regulation, such as: heating and/or cooling elements integrated into the enclosure; intelligent control of airflow, insulation, and thermal regulation components; automatic adjustments based on sensed temperature, humidity, air quality, or detected stress indicators; and alerts or escalation if environmental parameters move outside predefined safe ranges. These features are intended to help maintain a safe and comfortable internal environment for the dog during all phases of transport, including pre-boarding, flight, and unloading.

Controller 125 may also store, stream, and/or play back pre-recorded or live video/audio content to animal 105 in the enclosure. Non-limiting examples of this content include owner-recorded reassurance messages, calming visuals, sounds, or combinations thereof. Such content may be triggered manually or automatically based on time, flight phase, environmental conditions, or detected stress indicators. Playback and usage events may be logged for later review.

These monitoring, communication, and environmental control features may be selectively enabled during airline transport by a user, meaning they may only be available for a certain time, such as the duration of the flight, or a period of time before or after, for example from check-in to retrieval of the enclosure after landing. Activation of the features may occur via a scan of the user's boarding pass, authorization token, booking reference, or flight-related event. Flight carriers may offer this functionality as an optional service to travelers, while the enclosure and its controls handle the underlying monitoring, control, communication, and data delivery.

The travel features may also be accessed via fee-based or premium access to certain in-transit monitoring, communication, and environmental control features. As one non-limiting example, airlines or transport partners may offer access to live viewing, two-way communication, enhanced sensor monitoring, anxiety-reduction content, or environmental regulation features as an optional paid service, similar to in-flight Wi-Fi or other premium airline offerings. Access may be enabled upon payment, authorization, booking reference, scan, or activation token. Access may also be time-limited to a specific flight, journey, or transport window. The enclosure and gateway 50 manage authentication, feature enablement, monitoring, and data delivery, and optionally billing. The airline carrier may also handle billing.

The terms “a” and “an” herein do not denote a limitation of quantity but rather denote the presence of at least one (1) of the referenced items.

The disclosure is not limited to the described embodiments, and a person skilled in the art will appreciate that many other embodiments of the disclosure are possible without deviating from the basic concept of the disclosure and that any such work around will also fall under scope of this disclosure. It is envisioned that other styles and configurations of the present disclosure can be easily incorporated into the teachings of the present disclosure, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

The foregoing descriptions of specific embodiments of the present disclosure have been presented for purposes of illustration and description. They are not intended to be exhaustive or to limit the disclosure to the precise forms disclosed, and obviously many modifications and variations are possible in light of the above teaching. The embodiments were chosen and described in order to best explain the principles of the disclosure and its practical application, to thereby enable others skilled in the art to best utilize the disclosure and various embodiments with various modifications as are suited to the particular use contemplated.

1. An animal containment and automatic release enclosure comprising:
four enclosure walls;
an enclosure top;
an enclosure bottom, wherein the four enclosure walls, enclosure top, and enclosure bottom form an enclosure that defines an interior enclosure space;
an enclosure door within one of the enclosure walls, wherein the enclosure door opens and closes to allow access to the interior enclosure space;
a door control device attached to one of the four enclosure walls, enclosure top, and enclosure bottom; and
a controller attached to one of the four enclosure walls, enclosure top, and enclosure bottom, wherein the door control device is in communication with and controls the enclosure door to open and close, wherein the controller is in communication with the door control device, and wherein the controller is configured to send a signal to the door control device to open or close the enclosure door.

2. The animal containment and automatic release enclosure of claim 1, wherein the door control device is selected from the group consisting of a linear actuator, a servo drive, a dual solenoid, a spring device, and any combinations thereof.

3. The animal containment and automatic release enclosure of claim 1, further comprising a wireless transmitter connected to one of the four enclosure walls, the enclosure top, or the enclosure bottom, wherein the wireless transmitter is in communication with the controller and configured to communicate with a personal communication device of a user, so that the user can send a command to the controller through the wireless transmitter to open or close the enclosure door.

4. The animal containment and automatic release enclosure of claim 3, wherein the personal communication device has an application thereon, so that the controller communicates with the application via the wireless transmitter and the user sends the command through the application.

5. The animal containment and automatic release enclosure of claim 1, further comprising an environmental control sensor attached to one of the four enclosure walls, enclosure top, and enclosure bottom, wherein the environmental control sensor measures at least one of a humidity inside the enclosure, a level of carbon monoxide inside the enclosure, the presence or absence of moisture on the floor of the enclosure, a temperature inside the enclosure, the presence of fire within or near the enclosure, a level of light in the enclosure, and a particulate level in the air inside the enclosure, and wherein the environmental control sensor is in communication with the controller.

6. The animal containment and automatic release enclosure of claim 5, wherein the controller is configured to send a signal to the door control device to open the enclosure door and/or a notification to the personal communication device when the controller receives a measured value from the environmental control sensor that is above a threshold value.

7. The animal containment and automatic release enclosure of claim 6, wherein the controller is configured to store measurement data from the environmental control sensor and data relating to when the door control device opens or closes the enclosure door.

8. The animal containment and automatic release enclosure of claim 1, further comprising a camera therein.

9. An animal containment and automatic release enclosure comprising:
four enclosure walls;
an enclosure top;
an enclosure bottom, wherein the four enclosure walls, enclosure top, and enclosure bottom form an enclosure that defines an interior enclosure space; and
an enclosure door within one of the enclosure walls, wherein the enclosure door opens and closes to allow access to the interior enclosure space;
wherein one of the four enclosure walls, the enclosure top, and the enclosure bottom is a hybrid wall made of a combination of metal and plastic.

10. The animal containment and automatic release enclosure of claim 9, further comprising a door control device attached to one of the four enclosure walls, enclosure top, and enclosure bottom; and
a controller attached to one of the four enclosure walls, enclosure top, and enclosure bottom, wherein the door control device is in communication with and controls the enclosure door to open and close, wherein the controller is in communication with the electric door control device, and wherein the controller is configured to send a signal to the door control device to open or close the enclosure door.

11. The animal containment and automatic release enclosure of claim 9, wherein the hybrid wall has a border portion made of plastic and a center portion made of metal.

12. The animal containment and automatic release enclosure of claim 11, wherein the center portion is rotatable, to allow access to the inside of the enclosure.

13. The animal containment and automatic release enclosure of claim 9, wherein the hybrid wall is at least partially hollow.

14. The animal containment and automatic release enclosure of claim 13, further comprising a component box within the hollow hybrid wall, wherein the component box stores electrical components therein.

15. The animal containment and automatic release enclosure of claim 9, wherein the four enclosure walls, the enclosure top, and the enclosure bottom are connected to one another with a snap-fit connection.

16. The animal containment and automatic release enclosure of claim 10, further comprising a camera connected to one of the enclosure top, the enclosure bottom, and the four enclosure walls, wherein the camera is in communication with the controller, and transmits and receives audio and/visual content from the personal communication device of the user to and from the enclosure.

17. A method of transporting the animal containment and automatic release enclosure of claim 1, the method comprising the steps of:
checking the enclosure with a transit carrier during a trip, wherein the enclosure will be in a secure location away from a user during the trip; and
allowing the user to access the controller through a secure wireless portal.

18. The method of claim 17, wherein the enclosure further comprises a camera, wherein the method further comprises the step of:
allowing the user to transmit audio and/or video content to an interior of the enclosure via the camera.

19. The method of claim 17, wherein the enclosure further comprises:
an environmental control sensor attached to one of the four enclosure walls, enclosure top, and enclosure bottom, wherein the environmental control sensor measures at least one of a humidity inside the enclosure, a level of carbon monoxide inside the enclosure, the presence or absence of moisture on the floor of the enclosure, a temperature inside the enclosure, the presence of fire within or near the enclosure, a level of light in the enclosure, and a particulate level in the air inside the enclosure, and wherein the environmental control sensor is in communication with the controller; and
at least one of a heater, a cooler, and a fan, and
the method further comprises the step of:
activating at least one of the heater, cooler, and fan to adjust an environmental condition in the enclosure when the controller determines that a measurement from the environmental control sensor is outside a set range.

20. The method of claim 17, wherein the user is only allowed access to the controller during the trip.
